(19) United States
(12) Patent Application Publication
(10) Pub. No.: US 2010/0250363 A1
(43) Pub. Date: Sep. 30, 2010

(54) EXCHANGE BASED ON TRADERS BUYING AND SELLING FICTITIOUS SHARES OF CONTENT TYPES BASED UPON ANTICIPATED RETURNS OF SUCH CONTENT

(75) Inventors: Malik Magdon-Ismail, Loudonville, NY (US); Parag Patel, Calabasas, CA (US)

Correspondence Address: PARAG PATEL, 4708 LA VILLA MANNA, UNIT G, MARINA DEL RAY, CA, 90292, US

(73) Assignee: SWOOGE, LLC, Loudonville, NY (US)

(21) Appl. No.: 12/814,365

(22) Filed: Jun. 11, 2010

Related U.S. Application Data
(63) Continuation-in-part of application No. 11/552,268, filed on Oct. 24, 2006, now abandoned.
Application No. 11/552,268 is a continuation-in-part of application No. 11/677,172, filed on Feb. 21, 2007.
Application No. 11/677,172 is a continuation-in-part of application No. 12/104,899, filed on Apr. 17, 2008.
(60) Provisional application No. 61/218,266, filed on Jun. 18, 2009.

(51) Int. Cl. G06Q 40/00; G06Q 30/00

(52) U.S. Cl. 705/14.43; 705/37

(57) ABSTRACT

A method and system for generating data related to a plurality of content types across one or more category-types by facilitating the exchange of fictitious shares of the plurality of content types is provided and for encouraging users to join and actively participate in said exchange.

### CROSS-REFERENCE TO RELATED APPLICATIONS

This Application is a continuation in part of U.S. patent application Ser. No. 11/552,268 (filed on Oct. 24, 2006), U.S. patent application Ser. No. 11/677,172 (filed on Feb. 21, 2007) and U.S. patent application Ser. No. 12/104,899 (filed Apr. 17, 2008). The entire disclosures of these priority applications are hereby incorporated by reference herein.

### STATEMENT RE: FEDERALLY SPONSORED RESEARCH/DEVELOPMENT

Not Applicable

### OVERVIEW OF THE TRADING PLATFORM

Patent application Ser. No. 11/677,172 relates generally to a system and method of generating website-related data. More specifically, it pertains to a system and method for the creation of a website exchange and the online trading of fictitious shares of a plurality of websites to generate website-related data that provides an indication of the value of a website. The website-related data may be provided to advertisers or market analysts as a website evaluation tool. Patent application Ser. No. 11/552,268 relates generally to the use of a toolbar to track a user's navigational history. U.S. patent application Ser. No. 12/104,899 provides a method and system for collecting and using in combination, data from information sources, including a website-traded exchange and a tracking toolbar, in a correlated manner to deliver more relevant and effective advertising.

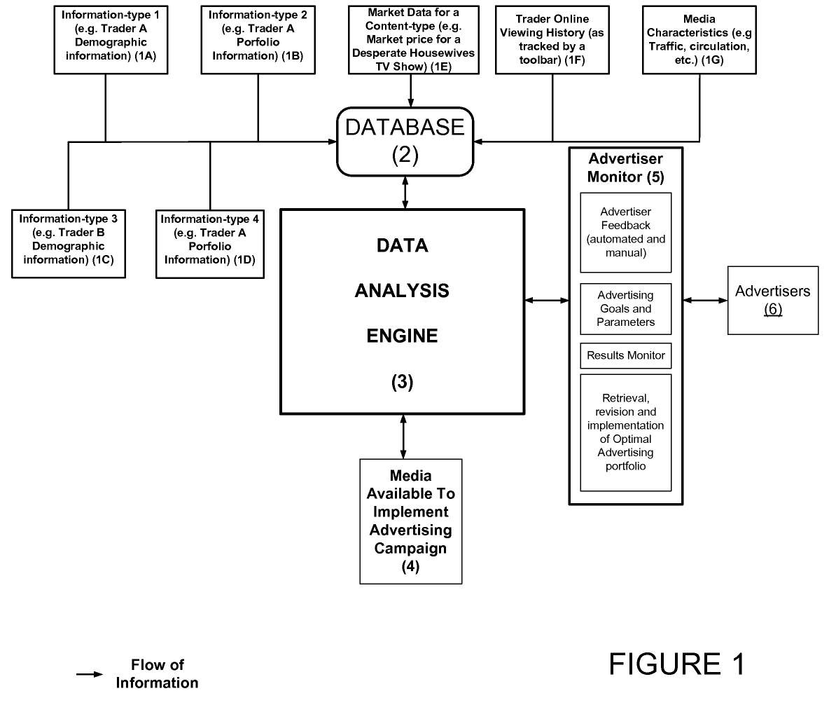

The present invention also pertains to a system and method of using an online exchange that facilitates trading of fictitious shares in order to generate data (see FIGS. 1-8 of incorporated specification of patent application Ser. No. 11/677,172), but this system and method extends to concurrent trading of other forms of content-types, such as media (e.g. television shows, radio, newspapers, magazines, websites and other online platforms or communication methods (e.g. twitter)), interests (e.g. celebrities, politicians, movies, colleges, sports teams and individual sportspersons, fashion, music and musicians) and products/services (e.g. automobiles, electronics, financial services, travel, fashion and other highly advertised products/services).

For example, traders may buy and sell fictitious shares for the series “Desperate Housewives” (or for a specific episode of Desperate Housewives (akin to trading a subsidiary stock of a parent company)). Likewise, traders may trade fictitious shares in a famous actor, musician or political figure (activity may reflect current popularity in a movie, song or performance). Each trading commodity (e.g. a movie star, TV series or show, sports team, automobile, videogame, etc.) is a “content-type”. Traders may base their trades for a content type on one or more factors, such as ratings, past performance, current industry, buzz, viewer perception of a show series (or the last episode), awards won, word of mouth, revenues generated and other information provided to them (e.g. toolbar-tracked information).

In one embodiment of the invention, separate exchanges exist for each “category type” (e.g. media-type, interests, products, services, etc.). In another embodiment, a unified exchange exists so a trader may trade content-types across one or more category-types using the same portfolio (e.g. a trader may have a single portfolio consisting of stocks for websites, TV shows and cars). Accordingly, users may trade shares for websites, automobiles, electronics (e.g. MP3 players), television programs, radio programs, commercials (all media types), magazines, video games, films (full length and shorts), internet content (e.g. video-clips, on YouTube and other movie-sharing networks) and celebrities (e.g. movie actors, music artists) on one unified exchange. To attract a wider range of audience and gather more data, multiple single or cross-category-type exchanges (e.g. one exchange may include only the top 40 TV shows, 300 websites, 10 newspapers and 30 magazines whereas a broader exchange may include more (or other) content-types across several category-types) may be created to include less “liquid” content-types (e.g. less popular or well-known TV shows, cars or websites). A house account can be instituted to provide an optimal amount of liquidity for such content-types. Several types of house account and other methodologies (such as automated market-makers as described in Das and Malik Magdon-Ismail “Adapting to a Market Shock: Optimal Sequential Market-Making”, Proc. Advances in Neural Information Processing Systems (NIPS), pages, December 2008) are well known in the art of predictive markets to bring liquidity to such games.

The present invention also expands on the toolbar invention in application Ser. No. 11/552,268 in that the present toolbar is additionally configured to track a user's online viewing of media content (e.g. online TV shows, satellite or regular radio broadcasts, online subscriptions to print media, such as newspapers and magazines). With the convergence of the internet, television and other media (c.f. YouTube, Hulu, Joost, Apple TV, mobile TV on handheld devices), the ability to track a user's content type preference is greatly enhanced using monitoring software (e.g. a toolbar) on a computer or handheld device (e.g. iPod, iPhone, iTouch, Zune, mobile devices) which is either wireless or can be synchronized with a device (e.g. a personal computer) that is capable of accessing the internet. Information tracked in this manner provides useful information to both traders and to advertisers.

The most efficient way for a business to utilize its advertising budget is to direct spending toward those who are most likely to be interested in the goods or services that the business can provide to potential purchasers. Unfortunately, the efforts to target only those individuals that have the highest probability of buying have not always been so easy, especially with traditional methods of advertising. For instance, large sums of money are spent on television advertisements that are broadcast to the population during commercial breaks of programming Demographic studies are continuously conducted to determine the likes, dislikes, and other lifestyle behaviors of the television viewing audience of a particular channel or program. Businesses use this information to advertise during particular time slots of programs, such as during the commercial breaks, to reach a specific target audience that is most likely to be interested in their products based on these demographic studies. However, there is no guarantee that the particular viewing audience will have any interest in the goods or services that are being advertised by the business. Further, digital video recorders and other similar types of technology enable television viewers to skip over or avoid most, if not all, of the advertising on television. A target audience may not even be aware of the business or the goods and services it offers. Ratings data from providers such as Nielsen provide most of the information based on a small sample of viewers (approximately 10,000 households). Similar problems exist in other forms of media, and advertisers typically have little quantitative data (Nielsen's AtPlan service, for example, collects qualitative survey information for its cross-platform data service) on how to allocate their spending budget across media-platforms to obtain the most effective use of their advertising dollars. Accordingly, a better and more trackable method of obtaining reliable data on viewing, listening or reading habits of an audience over one or more media-types is needed.

### DETAILED DESCRIPTION

A method for generating data related to a plurality of content types by facilitating the exchange of fictitious shares of the plurality of content types, the method comprising the steps of: correlating a predetermined number of fictitious shares to each content type; setting a market price for the fictitious shares of each content type; generating an electronic currency; receiving requests to execute orders related to the fictitious shares of the content types in connection with the electronic currency; and adjusting the market price of the fictitious shares of the respective content types to reflect a current market price based on the requests to execute orders. An additional step may include ranking the plurality of content types based on the respective current market price of the fictitious shares of the content types.

Market price data generated from the method may be useful to advertisers and other analysts because it provides a market prediction of the future success of a content type as it relates to the market price of the shares and rank of the content type. In order to generate predictive data, predictive markets must be constructed such that every content-type requires the participant to receive a dividend based on the accuracy of his or her prediction. Methods of constructing appropriate dividends for certain content-types are well known (e.g. The Hollywood Stock Exchange requires a participant to predict the weekend gross revenues of a movie; predictive markets for certain TV shows use Nielsen ratings). Nonetheless, dividends are not easily constructed and current methods do not generate the most useful predictive data. In one embodiment of the present invention, dividends may be constructed based on one or more of the following:

Participant polls, surveys and other user-generated data relevant to specific content types.

For television shows—total (or pre-sale) advertising spend (e.g. the amount of advertising sold at the annual Television UpFronts event in New York), number of times a show appears on a top Nielsen list over a certain time-period (e.g. a weekly top 20 ratings), the actual ranking each time that a show appears on a top Nielsen list, page-views of related online content, downloads or streaming of a show online, number of rentals (e.g. DVD rentals) of a show.

For sports—rankings of team or individuals, prize money collected over certain time-periods, results (of upcoming matches, events, tournaments), amounts of sponsorships/endorsements/merchandising contracts and of other products/services by teams and/or individual sports celebrities.

Colleges—rankings (based on popular and reliable publications, such as US News and World Report, Barrons, etc.), incoming student statistics, participant polls and surveys on specific college attributes (e.g. party school or not, academic perceptions, attractiveness of male or female students), graduating student statistics (e.g. median income), total research dollars, quality and quantity of research publications, endowments, individual department rankings, performances of the college's sports teams.

Music Artists/Bands (referred to collectively herein as artist)—number of songs sold (including downloads, streaming, etc.), number of times an artist (and/or song by artist) appears on a ranking chart (e.g. Top 10 BillBoard) over a certain time-period, the actual ranking each time the song and/or artist appears on a ranking chart, revenues generated by artist over certain time-periods for works, amounts generated by sponsorships/endorsements, merchandizing contracts and other services/products related to artist's persona, number of appearances on TV shows, movies, magazines etc., revenues from concert sales.

Videogames (includes both videogame software and hardware manufacturers, although latter may also be included in Electronics category below)—number of games sold (including subscriptions, downloads, streaming, etc.), number of times the videogame software manufacturer (e.g. Nintendo and/or games played on the Nintendo platform) appears on a ranking chart (e.g. NPD Top 10 videogame sales) over a certain time-period and the actual ranking each time it appears, revenues generated by manufacturer or producer over certain time-periods.

Autos (Manufacturers, e.g. Ford, BMW): Revenues generated from a certain number (e.g. top 3) of top selling brands. Ratings on consumer guides for various categories (e.g. Safety, overall quality, mileage/gallon, number of times in garage in first year), average resale value after certain periods of time (e.g. 1, 2, 3, 5, 10 years); performance characteristics of new model (e.g. time to accelerate from zero to 60); amount spent on advertising, stock market price of manufacturer.

Fashion (Designers, e.g. DKNY, LEVI, GAP, ANNTAYLOR): Number of celebrities wearing at events (e.g. Oscars), revenues from sales (online and retail), stock market price, appearance in media (e.g. magazines, websites, etc.), advertising dollars spent, brand recognition, website traffic, number of exhibitions at top fashion shows, prominence of spokespersons (e.g. market price on the exchange of the celebrity or fashion model that wears or endorses the fashion brand).

Electronics (Manufacturers and Products: e.g. iPhone, Sega, Garmin, Wii, Sony, Samsung): Revenues from top products, number of items sold, stock market price, buzz factor (e.g. from Yahoo! Buzz website), reach and penetration of product, consumer report ratings, user reviews (e.g. CNET, Amazon user ratings), defect rates, customer satisfaction/service, pricing of offered product, number of items sold within a certain time-period (e.g. first two weeks of product launch).

Websites: Traffic statistics and demographics, including pageviews, time spent on site, advertising revenues, click through efficiencies (i.e. advertising effectiveness)

Magazines: Circulation numbers, how often and actual ranking in a top circulation (e.g. the top 20 by circulation) over a certain time period; prominence of celebrities appearing on front page (e.g. market price on the exchange of the celebrity); number of registered users and page views of online versions of the magazines; advertizing-related measure (e.g. revenues over a certain time-period).

Newspapers: Circulation numbers, how often and actual ranking in a top circulation (e.g. the top 20 by circulation) over a certain time period; number of registered users and page views of online versions of the newspapers; Advertizing-related measures (e.g. revenues over a certain time-period).

Current Events (e.g. Elections): Typically binary events (whether it happened or not).

### Methods for Computing Dividends

The dividend calculation method may be defined by the following process and its obvious variations:

1. Let the factors for a particular content type be defined as given above.

2. If X is a factor then any standard function available to anyone skilled in the field F(X) is an additional factor. For example F(X)=sin(X), F(X)=exp(X), F(X)=square(X), F(X)=log(X), inverse(X), etc.

3. If X1 and X2 are any two factors (which could include factors defined through 2) then for two arbitrary (positive or negative) weights W1 and W2, the factor X3=W1*X1+W2*X2 is also an additional factor. Note that in this description, X1 and X2 may be factors for different content types. Thus it is possible to combine (for example circulation numbers of a magazine and rating of a TV show to compute a factor for an actor).

We define the set of all available factors as the basic factors specific to the content types, together with all other factors obtained through the repeated application of 2. And 3. The dividend for any specific content type is then one of the available factors.

Any number of fictitious shares may be correlated to a content type. Alternatively, the number of fictitious shares may depend on external factors, which may include longevity of a content type, popularity or performance of performers (actors, singers, writers, sports athletes etc.), user/viewer ratings, product anticipation (e.g. the iPhone, new car models, etc.) industry buzz, ratings, team/individual rankings, tracked user data (obtained using the tracking toolbar) and the like. A predetermined number of fictitious shares of stock may also be correlated to a subsidiary content type (e.g. for a single television episode or sporting event). Similarly, the initial market price for the fictitious shares may be arbitrarily set or the initial market price may depend on external factors.

According to one aspect of the invention, instead of or in addition to the step of ranking a content-type based on a market price, the method may comprise the steps of obtaining user/viewer ratings information, trader portfolio information and/or trader demographic information (each of which shall be referred to herein as an “information-type”) for at least one of a given number of content-types and then ranking the plurality of content types based on one or more of those information types. Alternatively, the method may comprise the steps of obtaining one or more information type(s) and then using those one or more information type(s) either in combination or separately for the analysis, processing and generation of reports by a database management system.

The following expands on the steps regarding the obtaining and/or processing of an information-type. These steps may involve the obtaining and/or processing some or all the data from the portfolio compositions (and changes therein) of one or more traders. Additional or alternate steps may include the obtaining and/or processing the demographic data of one or more traders or other information types. By obtaining and/or analyzing the portfolios (and changes therein) and/or the demographics of traders and/or other information-types, reports showing predicted market trends can be generated. Generally, traders may own various instruments across one or more category-types in their portfolios. Those same traders are also individuals that engage in other activities (e.g. watch television, buy cars, surf the internet, read newspapers or magazines). To infer properties about these other activities, the processing step may analyze trader portfolio compositions (and changes therein) either in combination with or independently of those traders' demographic backgrounds or other information types. Ultimately, analysis based on one information-type or on a combination of some or all information-types leads to more effective advertising opportunities for advertisers. See FIG. 1 for a drawing relating to the inputs and outputs for an example of such an embodiment of the invention. Specifically, FIG. 1 shows several inputs (1(A) to 1(G)) consisting of data relating to information-types (pertaining to Traders A and B), market data, trader online viewing history and media information (these are shown merely as examples of the types of inputs that may be received, and not as limitations of the types of inputs that may be received; the invention itself envisions one or more of these or other types of inputs as described herein). The data inputs are received by a Database (2) which is linked to a Data Analysis Engine (3) that performs analysis on such data inputs. Advertisers (6) may access the Data Analysis Engine (3) via an Advertiser Monitor (5) which contains several features (e.g. feedback, parameter input, results monitor and the like) and may implement an advertising campaign directly on Available Media (4) which is also linked to the Data Analysis Engine. Those in the art may implement the foregoing through other systems or methods obvious in the art, and the invention is envisioned to encompass all such variations.

The following are examples of how data from trader portfolios and/or demographics may be combined and analyzed to deliver more effective advertising opportunities. These examples are provided for illustrative purposes only, and are not intended to limit the methods or how such data may be combined to provide information on how to conduct more effective advertising.

(1) Inferential Demographic & State of Mind for Fat-Tail Media:

A trader's portfolio composition, positions, portfolio performance and relative volume of shares traded indicate his or her “state of mind”. When a group of similarly minded traders visit a “fat-tail” website (i.e. a non-traded website) as recorded by a tracking toolbar, common trading patterns and demographic information of those traders indicate the “state of mind” of general visitors to that fat tail website and hence provide intelligence on which (i.e. more relevant) advertisements to place on that website. For example: If traders visiting a certain non-traded fat tail website, are significantly long in technophile.com webshares, placing advertisements for technology products on that specific non-traded fat tail website would be recommended. As another example on another media-type, a trend showing that traders owning shares in Desperate Housewives also own shares of Discovery Network (a cable channel with lower advertising costs and more focused viewership) suggests that an advertiser may reach a similar audience to Desperate Housewives for a lower price.

(2) Cross Platform Portfolio Based Inference.

Patterns in cross-platform data based on portfolios with patterns of similarity may provide valuable information (e.g. a pattern that shows traders owning a particular brand's website (e.g. GM) also tend to own a certain TV show (e.g. Desperate Housewives) suggests that such brand should advertise on that TV show). A further pattern that shows traders shorting GM tend to buy iPhone shares suggests that Apple should not advertize iPhones on Desperate Housewives.

(3) Use of Cross Platform Portfolios to Determine Optimal Media Mix.

Percentage compositions of stocks in trader portfolios may also yield valuable information (e.g. looking at traders of GM's website stock, one could review what fraction of their portfolio is in TV vs. Radio vs. Print vs. other advertising platform to determine the fraction of the advertising budget which should be spent on each media platform).

Note that demographic information of the traders in each of the above three examples also provides valuable information about the target audience for a specific advertiser's goods or services.

(4) Use of Cross Platform Portfolio Data Across Time and/or Other Dimensions (e.g. demographics) to Identify Trends.

Changes in portfolio compositions over time may also yield valuable data. For example, a trend showing that significant numbers of traders in a certain location (determined using IP addresses or demographic information inputted by traders) selling Ford F150 trucks shares and purchasing Ford Escort car shares over a certain time period may advise Ford to change its advertising campaign in that location (either bolster the image of Ford 150 trucks or increase its campaign for Escorts or both).

(5) Demographic Stratification Analysis of Cross-Platform Data

Stratification of traders along a particular dimension (e.g. Gender, Age) may be used to identify more effectively cross-platform opportunities. For example, data showing that both men and women own Desperate Housewives shares, but men tend to own more Google shares and women own more MSN shares, suggest that advertisers who want to advertise on Desperate Housewives, but either do not want to pay the premium or cannot obtain an advertising slot, can reach the same audience on the Internet with even further stratification.

According to another aspect of the invention, the method may further comprise a step of requiring a user to register for a trader account, wherein the receiving step includes receiving a request to execute an order from the user via the trader account. The trader account may be modified in response to a request to execute an order received from a user. The user may provide demographic data that is stored in association with the trader account. The demographic data may be provided to a third party in addition to the historical market price data and the predictive market price data.

According to another aspect of the invention, the method may further comprise a step of storing data, such as historical trader portfolios, trader demographics and market price data for the shares of the content types. The historical trader portfolios data may include portfolio composition and details of trades made (time, number of shares, price, etc.). The historical market price data includes at least one of an initial market price per fictitious share, a current market price per fictitious share, a previous market price per fictitious share, a current content type rank and a previous content type rank The method may further comprise a step of deriving a prediction of market data for at least one of a given number of content types, wherein the predictive market price data is derived from at least the historical market price data for the content types. The prediction of market data may include a future content type rank, future user/viewer data and future market price per fictitious share. The historical market price data and the prediction of market data may be provided to a third party such as an advertiser or other analyst.

According to another aspect of the invention, the method may comprise a step of providing information from tracking users' online viewing of various media types to traders on the Exchange. Such information may be tracked using a toolbar accordingly to the description in application Ser. No. 11/552,268, but which is additionally configured to monitor and track online viewing of media content (e.g. online TV shows, satellite or regular radio broadcasts, online subscriptions to print media, such as newspapers and magazines).

A system for generating data related to a plurality of content types by facilitating the exchange of fictitious shares of the plurality of content types, the system comprising: a host server configured to receive and transmit data related to the fictitious shares of the plurality of content types over a global communications network, the host server including: a client interface configured to direct communications received over the global communications network between the host server and a client device; a transaction engine configured to respond to orders associated with the exchange of the fictitious shares of the plurality of content types, the orders being received by the host server from the client device via the client interface; a pricing engine configured to receive data from the transaction engine related to the orders, the data related to the orders being used to calculate a current market price of the shares for at least a given one of the plurality of content types; and a research engine configured to respond to a request for data related to the orders and a database configured to store the data related to the orders.

### INCENTIVIZING WEBSITE EXCHANGE PARTICIPANTS

Studies show that predictive markets generally provide accurate results by gathering the “collective wisdom of the crowd”. The information derived from the exchange described herein (the “Exchange”) contributes significant predictive data in the various manners described above. However, to obtain accurate and reliable predictive markets data, there needs to be a sufficient number of participants and those participants need to engage in intelligent and non-arbitrary trades. Hence there exists a need to incentivize internet users to become predictive markets participants and then to trade intelligently and non-arbitrarily.

The following are methods and apparatus intended to incentivize internet users to become participants in the Exchange and then to trade intelligently and non-arbitrarily. Generally, in predictive markets simulations or games, participants are given an arbitrary amount of fictitious currency to trade. Contestant winners may be awarded cash and other types of prizes. In an embodiment of the present invention, participants are granted titles or elevated to prestigious status levels if they reach certain performance thresholds. Higher status levels may include additional benefits to the successful participants in manners unique to the Exchange. For example, a high status level participant may be accorded better margin privileges, allowing such participants to greater leverage their fictitious currency, thereby enabling them to reach higher status levels more rapidly, retain their lead and be awarded more prizes and other benefits. Such participants may also be provided their own blogs or other forums to communicate (in their capacity as a higher status level leader) with other visitors or participants on the Exchange. Yet another advantage to a high status level leader may include the ability to manage other participants' fictitious currency (for example, as a mutual fund or hedge fund manager).

In another embodiment of the present invention, Exchange participants are provided the option of downloading the tracking toolbar in exchange for bonus fictitious currency. They are also offered the option to accumulate additional bonuses on an ongoing basis if they permit the toolbar to track their internet activity (a stop-tracking button may be provided for privacy concerns if users wish to disable tracking on a temporary or permanent basis). Participants use their initial and bonus fictitious currency to trade. If they make a profit, they accumulate points (or some other measurable denomination of success) which they can redeem for cash, discounts, air-miles or some other form of consideration. Hence the more initial currency a participant obtains (through signing up, downloading the tracking toolbar, permitting tracking of his or her online activities, recruiting other participants (see below)), the greater his or her ability to generate a larger profit, and consequently to realize a larger cashback and/or other reward.

To encourage a participant to recruit others to participate, he or she may receive bonus fictitious dollars for referrals who sign up, with increasingly bigger bonuses if the referrals also download the tracking toolbar and permit tracking. Further, the referrer may receive additional bonuses if his or her referrals also generate positive returns on the Exchange (thereby incentivizing the entire group of referror and his or her referrals to play intelligently and non- arbitrarily). Referrals can also obviously refer others, creating their own referror-referrals group.

Bonuses may be further conditioned on (or the amount varied based on) verifiable demographics of referrals (e.g. higher bonuses may be offered to attract referrals with certain attributes, such as specific age groups, gender, residence, income levels, education level, etc.) To limit fraudulent sign-ups, whenever desirable, specific attributes and/or amount of bonuses may not be disclosed (e.g. only general statements relating to need for diversity may be made and/or past examples of bonuses based on diversity may be posted), thereby causing participants to refer a diverse group of referrals without informing potential referrals how to identify themselves fraudulently in order to obtain bonuses.

Caps on payouts and/or other precautionary measures (e.g. limiting bonuses to a referror to a certain number (e.g. 2) of levels down the referral chain, limiting number of referrals, etc.) may be instituted to optimize the balance between number of participants, intelligent playing and the cost to recruit such individuals. Fraudulent play (e.g. teaming with others to manipulate a website price by driving it high or low) may be reduced, if not eliminated, by paying bonuses to any referror-referrals group only for net total increases (although disassociations may be permitted under genuine circumstances) and/or limiting the number of accounts (by IP address or other techniques well-known in the art) to any one participant. An added advantage of basing bonuses on net increases in a markets settings is that one player's losses may offset's another's winnings, thereby limiting the amount of bonuses paid.

In addition to getting bonuses for rewards, participants using the tracking toolbar are also presented with bidding opportunities and may use their accumulated points to bid for and/or obtain discounts on goods or services for which the participant is actively seeking. Accordingly, participants have an incentive to play the game in an intelligent, non-arbitrary manner and to permit tracking by the toolbar. Additionally, the toolbar not only provides information (e.g. current or historic website price, ability to rate a website) to participants regarding websites that they are currently visiting, but also provides participants with a sense of belonging and satisfaction that they are part of the website exchange, supplying information to it and increasing the relevancy of advertisements in general.

In addition or in connection with the above, participants may be encouraged to participate more in the Exchange by making the cash prize depend, in some manner, on the amount of participation. For example, the cash prize for a certain time-period (e.g. a month) may be a percentage of advertising revenues generated by advertisements appearing or otherwise presented to participants over that time-period. Hence, the more interaction, the greater the advertizing revenue, the greater the cash prize to be awarded. Additional participation may include responding to polls, surveys, user-generated content (on wilds, forums, etc.) to create a social networking-type community. As explained above, the results from such responses may also be used to calculate dividends for certain content-types.

Apparatus that may be used to perform the above tasks include computers with memory and processors driven by software configured to perform those tasks and access to online communication networks such as the Internet. Detailed description of such apparatus may be found in U.S. patent application Ser. No. 11/677, 172 (filed on Feb. 21, 2007), whose entire disclosure is incorporated herein.

What is claimed is:

1. A method for generating data related to a plurality of content-types by facilitating the exchange of fictitious shares of at least two different content-types, the method comprising the steps of:
correlating a predetermined number of fictitious shares to each content-type;
setting a market price for the fictitious shares of each content-type;
generating an electronic currency;
receiving requests to execute orders related to the fictitious shares of the content-types in connection with the electronic currency;
adjusting the market price of the fictitious shares of the respective content-types to reflect a current market price based on the requests to execute orders; and
generating market data based on the market price of the fictitious shares of the respective content-types.

2. The method of claim 1, further comprising a step of ranking the plurality of content-types based on the market data.

3. The method of claim 2, wherein the step of ranking the plurality of content-types is based on the current market price and at least one factor.

4. The method of claim 2, wherein at least one factor associated with the content-type is utilized to set an initial market price of the fictitious shares of the content-type.

5. The method of claim 1, further comprising a step of storing market data for the fictitious shares of the respective content-types.

6. The method of claim 5, wherein the market data includes at least one of an initial market price per fictitious share, a current market price per fictitious share, a previous market price per fictitious share, a current content-type rank and a previous content-type rank

7. The method of claim 1, further comprising a step of requiring a user to register for a trader account, wherein the receiving step includes receiving a request to execute an order from the user via the trader account.

8. The method of claim 7, further comprising a step of modifying the trader account in response to a request to execute an order received from a user.

9. The method of claim 7, wherein the user provides demographic data that is stored in association with the trader account.

10. The method of claim 9, further comprising a step of providing the demographic data and market data to a third party.

11. A method for improving advertising effectiveness on one or more advertising platforms, the method comprising the steps of:
receiving market data from at least one content-type;
receiving at least one information-type for at least one said content-type; and
processing said data to obtain patterns within said data.

12. The method of claim 11, further comprising the steps of:
receiving Advertiser-specific parameters from an Advertiser;
computing and dynamically updating said advertising effectiveness of at least one adverting campaign with respect to said received Advertiser-specific parameters;
providing an enhanced portfolio of advertising opportunities to said Advertiser for said advertising campaign.

13. The method of claim 12, further comprising the step of:
implementing an advertising campaign based on said enhanced portfolio of advertising opportunities; and
providing feedback to Advertiser based on results from said advertising campaign.

14. The method of claim 12, further comprising the step of allowing said Advertiser to edit said enhanced portfolio of advertising opportunities.

15. The method of claim 11, further comprising the step of:
using said correlation trends to determine the advertising effectiveness of at least one advertising platform for at least one advertising campaign.

16. A system for generating content-type-related data in connection with an exchange of fictitious shares of a plurality of content-types, the system comprising:
a host server configured to receive and transmit data related to the fictitious shares of the plurality of content-types over a global communications network, the host server including:
a client interface configured to direct communications received over the global communications network between the host server and a client device;
a transaction engine configured to respond to orders associated with the exchange of the fictitious shares of the plurality of content-types, the orders being received by the host server from the client device via the client interface;
a pricing engine configured to receive data from the transaction engine related to the orders, the data related to the orders being used to calculate a current market price of the shares for at least a given one of the plurality of content-types; and
a research engine configured to respond to a request for data related to the orders; and
a database configured to store the data related to the orders.
